(19) United States
(12) Patent Application Publication
(10) Pub. No.: US 2006/0072648 A1
(43) Pub. Date: Apr. 6, 2006

(54) Clock generator and method of generating a spread spectrum clock (SSC) signal

(76) Inventors: Jong-hoon Kim, Hwaseong-si (KR); Jeong-hyeon Cho, Seongnam-si (KR)

Correspondence Address: HARNESS, DICKEY & PIERCE, P.L.C., P.O. BOX 8910, RESTON, VA, 20195, US

(21) Appl. No.: 11/242,913

(22) Filed: Oct. 5, 2005

(30) Foreign Application Priority Data
Oct. 5, 2004 (KR) 10-2004-0079197

(51) Int. Cl. H04B 1/69

(52) U.S. Cl. 375/130

(57) ABSTRACT

A clock generator and method of generating a spread spectrum clock (SSC) signal, in which a delay cell array (DCA) control signal may be output based on one of a received spread spectrum clock generator (SSCG) signal and a feedback signal. The SSC signal may be generated based on at least one of the DCA control signal and a plurality of path control signals. Modulation properties of the SSC signal may be controlled based on a plurality of path control signals.

### PRIORITY STATEMENT

This application claims the priority of Korean Patent Application No. 10-2004-0079197, filed on Oct. 5, 2004, in the Korean Intellectual Property Office, the disclosure of which is incorporated herein in its entirety by reference.

### BACKGROUND OF THE INVENTION

1. Field of the Invention

The present invention relates to a variable spread spectrum clock generator adapted for a system using two or more clock frequencies.

2. Description of the Related Art

The processing speed of a computer system may be improved as a clock signal frequency of the computer increases. However, as the frequency increases, electromagnetic interference (EMI) due to the high frequency clock signal also may increase. To prevent EMI, processing methods such as shielding and filtering may typically be implemented, but at a significant expense.

A spread spectrum technique modulates the clock signal frequency in an effort to spread energy concentrated at a specific frequency evenly over a wider frequency band. By using the spread spectrum technique, EMI can be reduced without using higher-cost shielding and/or filtering methodologies.

In general, a modified phase-locked loop (PLL) may be used to generate a spread spectrum clock signal. However, since the PLL can process only a relatively narrow frequency range, use of a PLL is generally not desirable for generating a spread spectrum clock signal.

However, a spread spectrum clock generator may be used for generating a spread spectrum clock signal. FIG. 1 is a block diagram of a conventional spread spectrum clock generator. Referring to FIG. 1, the conventional spread spectrum clock generator may include a plurality of delay cells 11, 12 . . . 13, each delay cell having a controller CON and a delay unit DEL. The conventional spread spectrum clock generator may also include a controller initializing unit CON INI 20 to initialize the state of a controller CON of a ‘fourth’ (or Nth) delay cell 13, and a clock generating unit CLOCK GEN 30 to provide a clock signal to the delay unit DEL of a first delay cell 11.

The delay cells 11 through 13 may be connected in series with one another, and a delay cell in the conventional spread spectrum clock generator may receive a signal only from a ‘previous’ or ‘upstream’ delay cell and transmit the signal only to the ‘next’ or ‘downstream’ delay cell. For example, in FIG. 1, a delay unit of the second delay cell 12 can receive signals only from a controller of the second delay cell 12 and a delay unit DEL of the first delay cell 11, and may transmit the signals only to the controller thereof and a delay unit DEL of a downstream or next third delay cell (not shown). Accordingly, spread spectrum clock (SSC) signals may be generated that correspond to clock signals generated by the clock generating unit 30. In other words, when a clock signal with a specific frequency is input, the conventional spread spectrum clock generator is designed to output a spread spectrum clock signal in only one form, where the form of the signal is typically determined in advance or set by the fixed hardware configuration of the conventional spread spectrum clock generator.

However, in an example, it may be desired that a plurality of clock signals with differing frequencies be used frequently within the same system. In this case, the conventional spread spectrum generator cannot be adapted for processing a plurality of different clock frequency signals in its present configuration. Hence, reduction of EMI may not be considerably improved since the hardware of the conventional spread spectrum clock generator has a fixed form.

### SUMMARY OF THE INVENTION

An example embodiment of the present invention is directed to a clock generator. The clock generator may include a delay cell array (DCA) controller receiving one of a spread spectrum clock generator (SSCG) signal and a feedback signal to output a DCA control signal, the SSCG signal determining whether spread spectrum processing is to be performed on an input clock signal. The clock generator may include a clock generating circuit outputting the feedback signal and a spread spectrum clock (SSC) signal based on the DCA control signal and a plurality of path control signals, wherein modulation properties of the SSC signal may be controlled based on the plurality of path control signals.

Another example embodiment of the present invention is directed to a clock generator. The clock generator may include a DCA controller outputting a DCA control signal based on receipt of one of a SSCG control signal and a feedback signal, the SSCG control signal determining whether spread spectrum processing is to be performed on an input clock input signal. The clock generator may include a clock generating circuit outputting a SSC signal corresponding to the feedback signal and the input clock signal, based on the clock input signal and the DCA control signal. The clock generating circuit may include a plurality of delay cells and a plurality of path control units, each delay cell further including a controller and a delay unit. A given controller of a given delay cell may output a controller signal received from one of another given delay cell and a given path control unit, and may output one of another controller signal in response to a delay signal of a corresponding delay unit included with the controller in its delay cell, and a delay signal from a delay unit included in another delay cell.

Another example embodiment of the present invention is directed to a method of generating a spread spectrum clock (SSC) signal. In the method, a delay cell array (DCA) control signal may be output based on one of a received spread spectrum clock generator (SSCG) signal and a feedback signal. The SSC signal may be generated based on at least one of the DCA control signal and a plurality of path control signals. Modulation properties of the SSC signal may be controlled based on a plurality of path control signals.

Another example embodiment of the present invention is directed to a clock generator. The clock generator may include a DCA controller outputting a DCA control signal in response to at least a SSCG signal, and a clock generating circuit outputting a SSC signal based on the DCA control signal and a plurality of path control signals. Modulation properties of the SSC signal may be controlled based on the plurality of path control signals.

Another example embodiment of the present invention is directed to a circuit for generating a SSC signal for an input clock signal having a plurality of clock frequencies. The circuit may include a clock generator for inputting the clock signal with the plurality of clock frequencies, and a DCA controller outputting a DCA control signal in response to at least a SSCG signal. The circuit may include a spread spectrum clock generating circuit outputting a SSC signal based on the DCA control signal and a plurality of path control signals. Modulation properties of the SSC signal may be controlled based on the plurality of path control signals.

Another example embodiment of the present invention is directed to a spread spectrum clock generating circuit for generating a SSC for an input clock signal having a plurality of clock frequencies. The circuit may include a plurality of delay cells delaying a received signal for a given period of time, at least one of the delay cells receiving the input clock signal, and at least one path control unit controlling paths of signals transmitted between the plurality of delay cells in response to a plurality of path control signals. The circuit may generate the SSC based on at least the plurality of path control signals, with modulation properties of the SSC signal controllable based on the plurality of path control signals.

Another example embodiment of the present invention is directed to a spread spectrum clock generating circuit for generating a SSC signal for an input clock signal having a plurality of clock frequencies. The circuit may include a plurality of delay cells, at least one of which is configured for delaying the input clock signal, and a plurality of path control units receiving a corresponding one of a plurality of path control signals. A corresponding path control unit may be arranged between a pair of delay cells. The circuit may generate the SSC based on at least the plurality of path control signals, with modulation properties of the SSC signal being controllable based on the plurality of path control signals.

Another example embodiment of the present invention is directed to a path control unit for a variable spread spectrum clock generator having a plurality of delay cells and being configured for generating an SSC signal from an input clock signal having a plurality of clock frequencies. The path control unit may control paths of signals transmitted between one or more of the plurality of delay cells in response to a given one of a plurality of path control signals input thereto. The path control unit may be configured for controlling modulation properties of the generated SSC signal based on the plurality of path control signals.

Another example embodiment of the present invention is directed to a method for generating a controller signal to initialize a state of a controller in a delay cell of a clock generator configured to generate a SSC signal corresponding to a clock signal input thereto. In the method, the controller signal may be generated based on at least one of a SSCG signal and the generated SSC signal.

### BRIEF DESCRIPTION OF THE DRAWINGS

Example embodiments of the present invention will become more fully understood from the detailed description given herein below and the accompanying drawings, wherein like elements are represented by like reference numerals, which are given by way of illustration only and thus are not limitative of the example embodiments the present invention.

FIG. 1 is a block diagram of a conventional spread spectrum clock generator.

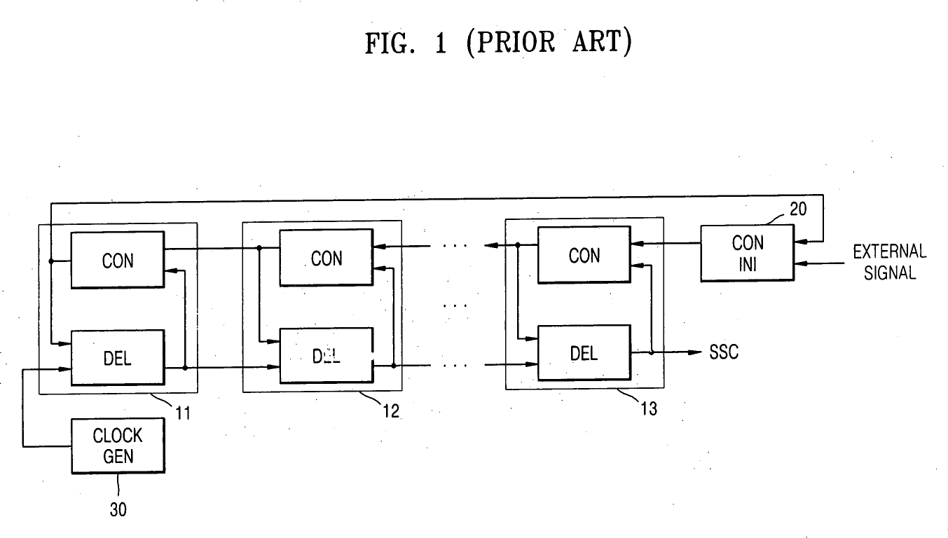

FIG. 2 is a block diagram of a variable spread spectrum clock generator according to an example embodiment of the present invention.

FIG. 3 is a block diagram of a variable spread spectrum clock generator according to another example embodiment of the present invention.

FIG. 4 is a block diagram illustrating the configuration of a path control unit and a delay cell included in the variable spread spectrum clock generator according to an example embodiment of the present invention.

FIG. 5 is a block diagram illustrating the configuration of the path control unit and a delay cell included in the variable spread spectrum clock generator according to another example embodiment of the present invention.

FIG. 6 is a block diagram of a spread spectrum generator in which there are two signal paths included in the variable spread spectrum clock generator according to an example embodiment of the present invention.

### DETAILED DESCRIPTION OF THE EXAMPLE EMBODIMENTS

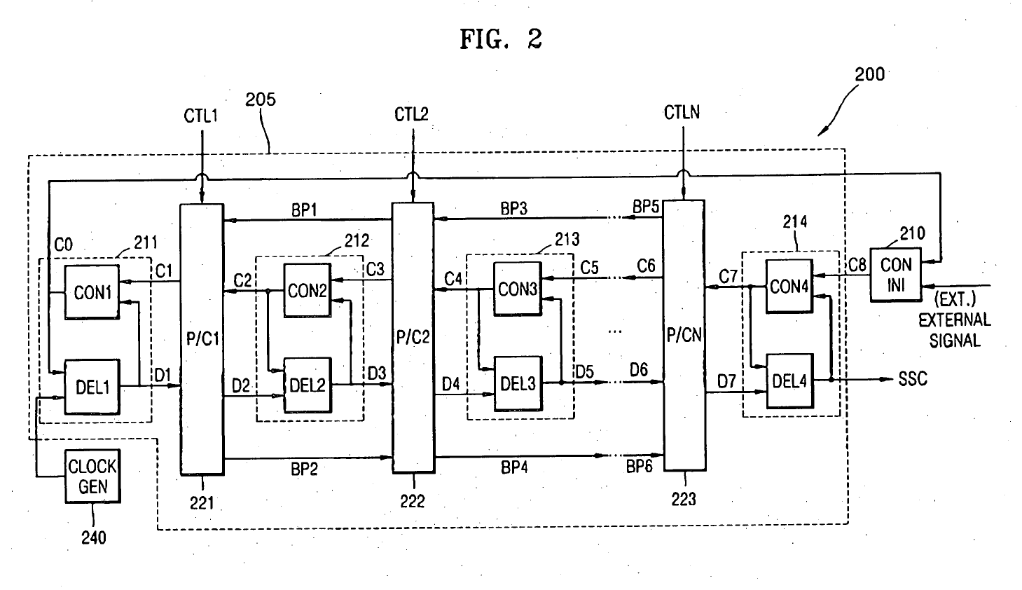

FIG. 2 is a block diagram of a variable spread spectrum clock generator according to an example embodiment of the present invention. Referring to FIG. 2, a variable spread spectrum clock generator 200 (‘clock generator 200’) may include a spread spectrum clock generating circuit 205. The spread spectrum clock generating circuit 205 may include a plurality of delay cells 211, 212, 213 and 214, each of which may include a controller CON and a delay unit DEL, and a plurality of path control units 221, 222 and 223. The clock generator 200 may include a delay cell array (DCA) controller CON INI 210 and a clock generator CLOCK GEN 240.

A first delay cell 211 may include a controller CON1 and a delay unit DELL. The controller CON1 may output a feedback signal C0 obtained using a first controller output signal C1 received from a first path control unit 221 and a first delay output signal D1 (‘first delay signal D1’) received from the delay unit DEL1. The delay unit DEL1 outputs the first delay signal D1 to the first path control unit 221 and the controller CON1. The first delay signal D1 may be delayed for a given time based on one or both of a periodic clock signal received from the clock generator 240 and the feedback signal C0 received from the controller CON1.

In response to a first control signal CTL1, the first path control unit 221 may select one signal from two received signals, a bypassed signal BP1 and a second controller output signal C2, outputting the selected signal (as C1) to the first delay cell 211, as shown in FIG. 2. Also, the first path control unit 221 may output the first delay signal D1 without modification to a second delay cell 212 (as D2), or may bypass the first delay signal D1 to output bypassed signal BP2 to a second path control unit 222.

The second delay cell 212 may include a controller CON2 and a delay unit DEL2. The controller CON2 may output the second controller signal C2, which may be obtained using a third controller signal C3 received from the second path control unit 222 and a third delay output signal D3 (‘third delay signal D3’) received from delay unit DEL2. The delay unit DEL2 outputs the third delay signal D3 to the second path control unit 222 and the controller CON2. The third delay signal D3 may be delayed for a given time based on one or both of a second delay output signal D2 (‘second delay signal D2’) received from the first path control unit 221 and a second controller signal C2 received from the controller CON2.

In response to a second control signal CTL2, the second path control unit 222 may select one signal from two received signals (bypassed signal BP3 and a fourth controller signal C4), outputting the selected signal (as third controller signal C3) to the second delay cell 212, or bypassing the selected signal (C3) and outputting the bypassed signal BP1 to the first path control unit 221. Further, the second path control unit 222 may output one of two received signals D3 and BP2 without modification to the third delay cell 213 (shown as fourth delay output signal D4 in FIG. 2) or bypasses a signal to a third path control unit (not shown) and outputs the bypassed signal BP4.

The third delay cell 213 may include a controller CON3 and a delay unit DEL3. The controller CON3 may output the fourth controller signal C4, which may be obtained using a fifth controller signal C5 received from the third path control unit (not shown) and a fifth delay output signal D5 (‘fifth delay signal D5’) received from the delay unit DEL3. The delay unit DEL3 outputs the fifth delay signal D5 to the third path control unit (not shown). The fifth delay signal D5 may be delayed for a given time based on one of both of the fourth delay signal D4 received from the second path control unit 222 and the fourth controller signal C4 received from controller CON3.

In response to an Nth control signal CTLN, an Nth path control unit (N being a positive integer) 223 may output a received signal (seventh controller signal C7) to an ‘M−1’th delay cell (not shown, M being a positive integer) or to an ‘N−1’th path control unit (not shown), and outputs received signals (sixth delay output signal D6 and bypassed signal BP6) to an Mth delay cell 214. The signal output to the ‘M−1’th delay cell is denoted as sixth controller signal C6, and the signal output to the Mth delay cell 214 is denoted as seventh delay output signal D7 (‘seventh delay signal D7’).

The Mth delay cell 214 may include a controller CON4 and a delay unit DEL4. The controller CON4 may output the seventh controller signal C7 obtained using an eighth controller signal C8 received from the DCA controller 210, and a spread spectrum clock (SSC) signal received from the delay unit DEL4. The delay unit DEL4 outputs the signal SSC, which may be delayed for a given time based on one or both of the seventh delay signal D7 received from the Nth path control unit 223 and the seventh controller signal C7 received from the controller CON4.

The DCA controller 210 may output the eighth controller signal C8 in response to a spread spectrum clock generator (SSCG) control signal (i.e., external signal EXT.), as shown in FIG. 2. The SSCG or EXT. signal determines whether spread spectrum processing is performed on an input clock signal and on the feedback signal C0 received from the first controller CON1.

As described above, the example variable spread spectrum clock generator 200 can be adaptively used for a plurality of clock frequency signals by controlling a plurality of control signals CTL1 through CTLN. Therefore, even when a frequency of the signal being used is altered or modified within a certain range, a clock generator for spreading energy of a signal can be obtained by controlling only a control signal, without any redesign or reconfiguration of the spread spectrum clock generator, as would be required in the conventional art.

Although the example embodiment of FIG. 2 describes one of the signals BP1 through BP6 output from a certain path control unit 221 through 223 bypassing a given delay cell, it would be evident to one of ordinary skill in the art for a given bypassed signal to bypass two or more delay cells.

Accordingly, FIG. 2 thus illustrates an example method of generating a spread spectrum clock signal. In the method, a SSCG signal is received which determines whether spread spectrum processing is to be performed on an input clock signal. A DCA control signal may be output based on at least one of the SSCG (EXT.) signal and a feedback signal, as shown in FIG. 2. Based on the DCA control signal and a plurality of path control signals CTL1-CTLN, a spread spectrum clock (SSC) signal may be generated, with modulation properties of the SSC signal being controlled based on the plurality of path control signals CTL1-CTLN.

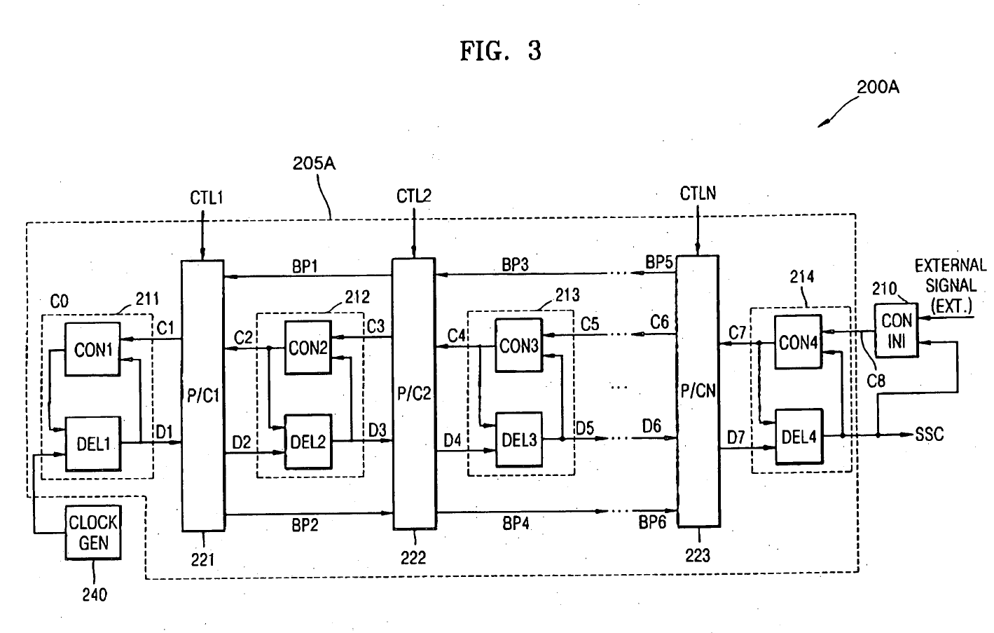

FIG. 3 is a block diagram of the variable spread spectrum clock generator 200A according to another example embodiment of the present invention. Referring to FIG. 3, the DCA control for the DCA controller 210 is different from that shown in FIG. 2. There is no feedback signal C0 output from the first controller CON1 and serving as an input to DCA controller 210. In other words, the input signal to the DCA controller 210 for generating the eighth controller signal C8 for output to the fourth delay cell 214 is based on to the SSCG control signal (or external signal EXT.) and/or a spread spectrum clock (SSC). As described above, the SSCG or EXT. signal determines whether spread spectrum processing is performed on an input clock signal generated by clock generator 240. Therefore, FIG. 3 may illustrate an example method for generating a given controller signal to initialize a state of a controller in a given delay cell of a spread spectrum clock generator, in which the controller signal is generated based on at least one of an SSCG control signal and a SSC signal.

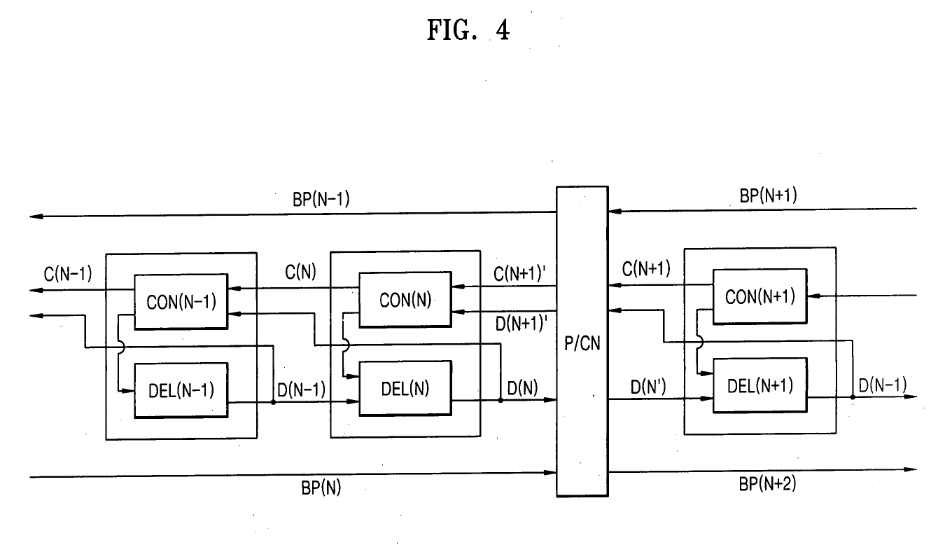

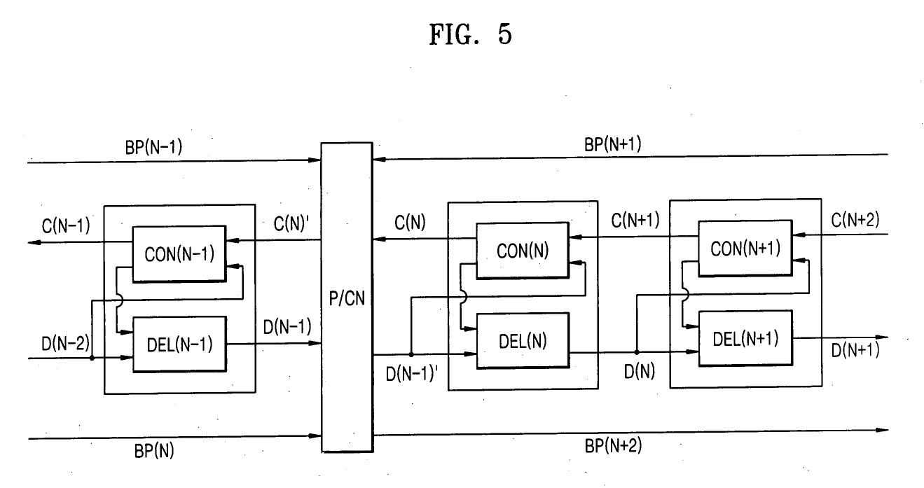

FIGS. 4 and 5 are block diagrams illustrating a configuration of the path control unit and the delay cell included in a variable spread spectrum clock generator according to two different example embodiments of the present invention. In general as shown in FIG. 2, a given controller (such as CON1) operates in response to the delay signal output from the delay unit (such as DEL1) included in the same delay cell (such as delay cell 211). However, as shown in FIG. 4, as the path of the clock signal delay goes from the left to the right, or ‘downstream’, an ‘N−1’th controller CON(N−1) (previous or ‘upstream controller’) operates in response to a delay signal D(N) output from an Nth delay unit DEL(N), (next or ‘downstream delay unit’), as shown with reference to FIG. 4. Further, referring to FIG. 5, a ‘downstream’ ‘N+1’th controller CON(N) operates in response to the delay signal D(N) output from an ‘upstream’ or previous Nth delay unit DEL(N).

The arrangement or configuration shown in FIGS. 4 and 5 are different from the configuration shown in FIG. 2, in that a given controller does not use the delay signal output from the delay unit included in its own delay cell, but uses the delay signal output from the delay unit included in the delay cell located before (previous or upstream) or next (downstream) to the delay cell including the given controller.

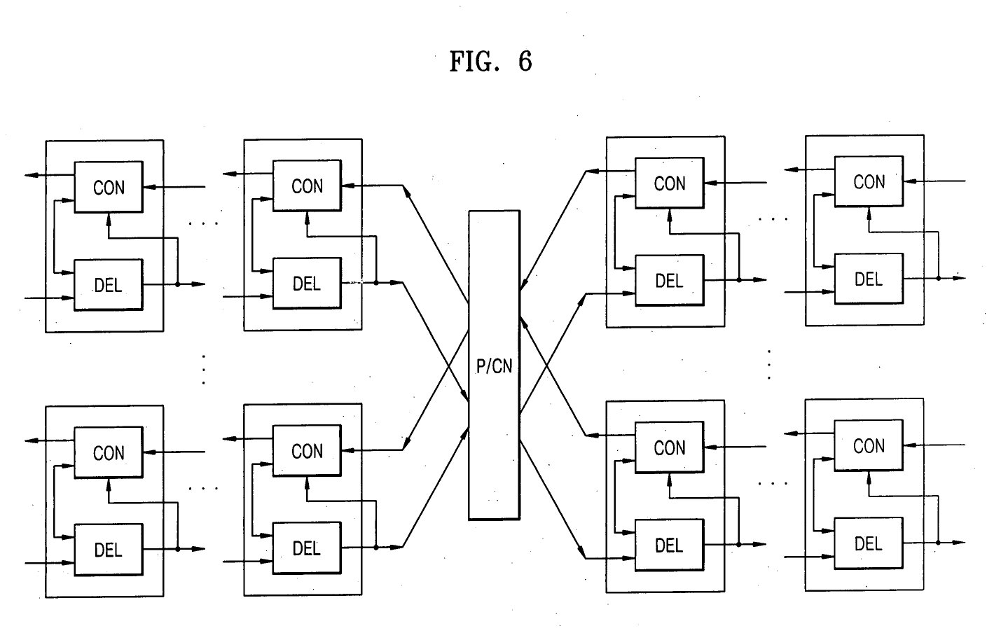

FIG. 6 is a block diagram of a spread spectrum generator in which there are two signal paths included in the variable spread spectrum clock generator according to an example embodiment of the present invention. Referring to FIG. 6, with a relatively minor modification to the delay cell configuration between the path control units P/CN, two signal paths can be configured. In light of FIG. 6, it is evident to those having ordinary skill in the art two or more signal paths can be achieved.

The variable spread spectrum clock generator in accordance with the example embodiments may thus generate a spread spectrum clock signal corresponding to a plurality of frequency signals using one or more given control signals. Therefore, adapting the example embodiments to a system using a plurality of frequency signals requires no reconfiguration of the spread spectrum clock generator, which may substantially design expenses.

While example embodiments of the present invention have been particularly shown and described, it will be understood by those of ordinary skill in the art that various changes in form and details may be made therein without departing from the spirit and scope of the example embodiments of the present invention, as defined by the following claims.

What is claimed is:

1. A clock generator, comprising:
a delay cell array (DCA) controller receiving one of a spread spectrum clock generator (SSCG) signal and a feedback signal to output a DCA control signal, the SSCG signal determining whether spread spectrum processing is to be performed on an input clock signal, and
a clock generating circuit outputting the feedback signal and a spread spectrum clock (SSC) signal based on the DCA control signal and a plurality of path control signals, wherein modulation properties of the SSC signal are controlled based on the plurality of path control signals.

2. The clock generator of claim 1, wherein the clock generating circuit includes:
a plurality of delay cells delaying a received signal for a given period of time, and
at least one path control unit controlling paths of signals transmitted between the plurality of delay cells in response to the plurality of path control signals.

3. The clock generator of claim 2, wherein at least one delay cell is arranged in adjacent relation to at least one path control unit, or between the plurality of path control units and the plurality of delay cells.

4. The clock generator of claim 3, wherein
each of the plurality of delay cells includes a controller and a delay unit,
the controller outputs a controller signal received from one of another delay cell and a given path control unit, and outputs another controller signal in response to a delay signal included in its corresponding delay cell or a delay signal included in another delay cell, and
the delay unit, after delaying the delay signal for a given delay time selected from one of a plurality of delay times determined in advance for each delay cell, outputs the delay signal received from the given path control unit or other delay cell, in response to another control signal.

5. The clock generator of claim 2, wherein the clock generating circuit includes:
a first delay cell receiving an output signal of the clock generator and a second controller signal from one of a second delay cell and a first path control unit, and outputting a first controller signal and a first delay signal,
an N^{th} (N being a positive integer) delay cell outputting an N^{th} controller signal and the SSC signal in response to an N+1^{th} controller signal and an N+1^{th} delay signal received from a given path control unit,
a plurality of delay cells arranged between the first delay cell and the N^{th} delay cell, and
a plurality of path control units arranged between the first delay cell and the N^{th} delay cell, wherein
the feedback signal is one of the first through N+1^{th} controller signals or first through N+1^{th} delay signals.

6. A clock generator, comprising:
a DCA controller outputting a DCA control signal based on receipt of one of a SSCG control signal and a feedback signal, the SSCG control signal determining whether spread spectrum processing is to be performed on an input clock input signal, and
a clock generating circuit outputting a SSC signal corresponding to the feedback signal and the input clock signal, based on the clock input signal and the DCA control signal, wherein
the clock generating circuit includes a plurality of delay cells and a plurality of path control units, each delay cell further including a controller and a delay unit, wherein a given controller of a given delay cell outputs a controller signal received from one of another given delay cell and a given path control unit, and outputs one of another controller signal in response to a delay signal of a corresponding delay unit included with the controller in its delay cell, and a delay signal from a delay unit included in another delay cell.

7. The clock generator of claim 6, wherein the feedback signal is one of a controller signal output from one of the plurality of controllers and a delay signal output from one of the plurality of delay units.

8. A clock generator, comprising:
a DCA controller outputting a DCA control signal in response to at least a SSCG signal, and
a clock generating circuit outputting a SSC signal based on the DCA control signal and a plurality of path control signals, wherein modulation properties of the SSC signal are controlled based on the plurality of path control signals.

9. The clock generator of claim 8, wherein the clock generating circuit includes:
a plurality of delay cells delaying a received signal for a given period of time, and
at least one path control unit controlling paths of signals transmitted between the plurality of delay cells, in response to the plurality of path control signals.

10. The clock generator of claim 9, wherein at least one delay cell is arranged in adjacent relation to at least one path control unit, or between the plurality of path control units and the plurality of delay cells.

11. The clock generator of claim 10, wherein
each of the plurality of delay cells includes a controller and a delay unit,
the controller outputs a controller signal received from one of another delay cell and a given path control unit, and outputs another controller signal in response to a delay signal included in its corresponding delay cell or a delay signal included in another delay cell, and
the delay unit, after delaying the delay signal for a given delay time selected from one of a plurality of delay times determined in advance for each delay cell, outputs the delay signal received from the given path control unit or other delay cell, in response to another control signal.

12. The clock generator of claim 9, wherein the DCA controller outputs the DCA control signal in response to one of the SSCG signal and a feedback signal.

13. The clock generator of claim 12, wherein the clock generating circuit includes:
a first delay cell receiving an output signal of the clock generator and a second controller signal from one of a second delay cell and a first path control unit, to output a first controller signal and a first delay signal,
an N^{th} (N being a positive integer) delay cell outputting an N^{th} controller signal and the SSC signal in response to an N+1^{th} controller signal and an N+1^{th} delay signal received from a given path control unit,
a plurality of delay cells arranged between the first delay cell and the N^{th} delay cell, and
a plurality of path control units arranged between the first delay cell and the N^{th} delay cell,
wherein the feedback signal is one of the first through N+1^{th} controller signals or first through N+1^{th} delay signals.

14. The clock generator of claim 8, wherein the DCA controller outputs the DCA control signal in response to one of the SSCG signal and a feedback signal, or one of the SSCG signal and the generated SSC signal.

15. The clock generator of claim 8, wherein the SSCG signal determines whether spread spectrum processing is to be performed on the input clock signal.

16. A circuit for generating a SSC signal for an input clock signal having a plurality of clock frequencies, comprising:
a clock generator for inputting the clock signal with the plurality of clock frequencies,
a DCA controller outputting a DCA control signal in response to at least a SSCG signal, and
a spread spectrum clock generating circuit outputting a SSC signal based on the DCA control signal and a plurality of path control signals, wherein modulation properties of the SSC signal are controlled based on the plurality of path control signals.

17. The circuit of claim 16, wherein the SSCG signal determines whether spread spectrum processing is to be performed on the input clock signal with the plurality of clock frequencies.

18. The circuit of claim 16, wherein the circuit is configured to process the input clock signal with the plurality of clock frequencies by controlling the plurality of path control signals.

19. The circuit of claim 16, wherein the spread spectrum clock generating circuit includes:
a plurality of delay cells delaying a received signal for a given period of time, and
at least one path control unit controlling paths of signals transmitted between the plurality of delay cells, in response to the plurality of path control signals.

20. The circuit of claim 19, wherein
each of the plurality of delay cells includes a controller and a delay unit,
the controller outputting a controller signal received from one of another delay cell and a given path control unit, and outputting another controller signal in response to a delay signal included in its corresponding delay cell or a delay signal included in another delay cell, and
the delay unit, after delaying the delay signal for a given delay time selected from one of a plurality of delay times determined in advance for each delay cell, outputs the delay signal received from the given path control unit or other delay cell, in response to another control signal.

21. The circuit of claim 19, wherein the spread spectrum clock generating circuit includes:
a first delay cell receiving an output signal of the spread spectrum clock generating circuit and a second controller signal from one of a second delay cell and a first path control unit, and outputting a first controller signal and a first delay signal,
an N^{th} (N being a positive integer) delay cell outputting an N^{th} controller signal and the SSC signal in response to an N+1^{th} controller signal and an N+1^{th} delay signal received from a given path control unit,
a plurality of delay cells arranged between the first delay cell and the N^{th} delay cell, and
a plurality of path control units arranged between the first delay cell and the N^{th} delay cell.

22. The circuit of claim 21, wherein
the DCA controller outputs the DCA control signal in response to one of the SSCG signal and a feedback signal, or one of the SSCG signal and the generated SSC signal, and
the feedback signal is one of the first through N+1^{th} controller signals or first through N+1^{th} delay signals.

23. A spread spectrum clock generating circuit for generating a SSC for an input clock signal having a plurality of clock frequencies, comprising:
a plurality of delay cells delaying a received signal for a given period of time, at least one of the delay cells receiving the input clock signal, and
at least one path control unit controlling paths of signals transmitted between the plurality of delay cells in response to a plurality of path control signals,
wherein the circuit generates the SSC based on at least the plurality of path control signals, with modulation properties of the SSC signal being controlled based on the plurality of path control signals.

24. The circuit of claim 23, wherein at least one delay cell is arranged in adjacent relation to at least one path control unit, or between the plurality of path control units and the plurality of delay cells.

25. The circuit of claim 24, wherein
each of the plurality of delay cells includes a controller and a delay unit,
the controller outputs a controller signal received from one of another delay cell and a given path control unit in the circuit, and outputs another controller signal in response to a delay signal included in its corresponding delay cell or a delay signal included in another delay cell, and
the delay unit, after delaying the delay signal for a given delay time selected from one of a plurality of delay times determined in advance for each delay cell, outputs the delay signal received from the given path control unit or other delay cell, in response to another control signal.

26. A spread spectrum clock generating circuit for generating a SSC signal for an input clock signal having a plurality of clock frequencies, comprising:
a plurality of delay cells, at least one of which is configured for delaying the input clock signal, and
a plurality of path control units receiving a corresponding one of a plurality of path control signals, a corresponding path control unit arranged between a pair of delay cells, wherein the circuit generates the SSC based on at least the plurality of path control signals, with modulation properties of the SSC signal controlled based on the plurality of path control signals.

27. The circuit of claim 26, wherein
each delay cell includes a controller and a delay unit,
a given controller of a given delay cell outputs a controller signal received from one of another given delay cell and a given path control unit, and outputs one of another controller signal in response to a delay signal of a corresponding delay unit included with the controller in its delay cell, and a delay signal from a delay unit included in another delay cell.

28. The circuit of claim 27, wherein
the SSC signal is generated based on one or both of a DCA control signal and a feedback signal received by the circuit, and
the feedback signal is one of a controller signal output from one of the plurality of controllers and a delay signal output from one of the plurality of delay units.

29. A path control unit for a variable spread spectrum clock generator having a plurality of delay cells and being configured for generating an SSC signal from an input clock signal having a plurality of clock frequencies, the path control unit controlling paths of signals transmitted between one or more of the plurality of delay cells in response to a given one of a plurality of path control signals input thereto, the path control unit configured for controlling modulation properties of the generated SSC signal based on the plurality of path control signals.
